(19) United States
(12) Patent Application Publication
(10) Pub. No.: US 2011/0013867 A1
(43) Pub. Date: Jan. 20, 2011

(54) Reconfigurable Materials for Photonic System Embodiment

(76) Inventor: Hector J. De Los Santos, Irvine, CA (US)

Correspondence Address: WILSON DANIEL SWAYZE, JR., 3804 CLEARWATER CT., PLANO, TX, 75025, US

(21) Appl. No.: 12/789,014

(22) Filed: May 27, 2010

Related U.S. Application Data
(60) Provisional application No. 61/181,710, filed on May 28, 2009.

(51) Int. Cl. G02B 6/26

(52) U.S. Cl. 385/15

(57) ABSTRACT

A light guide device for steering an input light may include a PBC lattice having a input surface and a first surface. The input surface may receive the input light to cooperate with the first surface, and the PBC lattice may direct the input light to the first surface to output the light from the PBC lattice by a programmable lattice of defect. The PBC lattice may include a aperture adapted to be filled with fluid, and the PBC lattice may include a fluid valves adapted to cooperate with the aperture. The PBC lattice may include a layer of fluid to cooperate with the fluid valve and the aperture, and the PBC lattice may include a second surface for output of the light by reprogramming the lattice of defect. The PBC lattice may include a third surface for output of the light by reprogramming the lattice of defect, and the first surface may be substantially perpendicular to the input surface.

### PRIORITY

The present invention claims priority under 35 USC section 119 based upon a provisional application with a Ser. No. 61/181,710 which was filed on May 28, 2009.

### FIELD OF THE INVENTION

The present invention relates to PBC lattices and more particularly to a PBC lattice which is able to steer input light in accordance with defect lattices.

### BACKGROUND

Fluids have been used to change the properties of optical devices. In particular, fluids have been used with photonic bandgap crystals (PBCs), to perform only tuning i.e., the shifting of the system's frequency/wavelength response of the crystals.

### SUMMARY

A light guide device for steering an input light may include a PBC lattice having a input surface and a first surface. The input surface may receive the input light to cooperate with the first surface, and the PBC lattice may direct the input light to the first surface to output the light from the PBC lattice by a programmable lattice of defect.

The PBC lattice may include a aperture adapted to be filled with fluid, and the PBC lattice may include fluid valves adapted to cooperate with the aperture.

The PBC lattice may include a layer of fluid to cooperate with the fluid valve and the aperture, and the PBC lattice may include a second surface for output of the light by reprogramming the lattice of defect.

The PBC lattice may include a third surface for output of the light by reprogramming the lattice of defect, and the first surface may be substantially perpendicular to the input surface.

The second surface may be substantially perpendicular to the input surface, and the third surface may be substantially perpendicular to the input surface and substantially parallel to the first surface.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a top view of the light guiding device of the present invention;

FIG. 2 illustrates a cross-sectional view and side view of the light guiding device of the present invention;

FIG. 3 illustrates a top view of the light guiding device of the present invention;

FIG. 4 illustrates a top view of the light guiding device of the present invention;

FIG. 5 illustrates a top view of the light guiding device of the present invention;

FIG. 6 illustrates a top view of the light guiding device of the present invention;

FIG. 7 illustrates a top view of the light guiding device of the present invention;

FIG. 8 illustrates a perspective view of the light guiding device of the present invention;

FIG. 9 illustrates a perspective view of the light guiding device of the present invention;

FIG. 10 illustrates a side view of the light guiding device of the present invention;

FIG. 11 illustrates an end view of the light guiding device of the present invention;

FIG. 12 illustrates a circuit for analysis and design purposes in conjunction with the present invention;

FIG. 13 illustrates an alternative embodiment of the present invention.

### DETAILED DESCRIPTION

Fluids have not previously been used to effect the steering/redirection, splitting/combination, switching, or slowing/storage of the one or more incoming optical beams. The present invention combines functions by combining nanofluidics and PBCs in order to achieve the steering/redirection, splitting/combination, switching or slowing/storage of one or more incoming optical beams for implementing the optical analog of a doped semiconductor and, in particular, for dynamically reconfiguring a sub-lattice of “doping” defects in such a way that the states of wave propagation in desired portions of the system changes between a first state of extended (wave can propagate) and a second state of localized (waves cannot propagate). Under this scheme of the present invention, PBC defects may be introduced anywhere in the PBC based upon an algorithm or function which a user may be interested in implementing. The present invention yields a virtually substantially, near infinite configuration space of programmable/software/digitally-controlled functions.

The present invention achieves Reconfigurable Cellular Electronic and Photonic Arrays (RCEPAs) which achieves the ability for directly implementing complex systems as software-defined emulations and may enable configuring pre-built (but uncommitted) logic, interconnect, switching, memory and other resources to perform a desired set of functions. These capabilities are, in turn, enabled by the emerging availability of technologies, in the areas of materials and in micro- and nano-microelectro, (opto)-mechanical (NEM/MEM/NOEM/MOEM) structures. The present invention may open up opportunities for effecting reconfigurability mechanisms. The present invention achieves the realization of these RCEPAs, which may be as malleable and, conceptually, reformable, will give rise to a class of reconfigurable photonics to provide expressions of pervasive morphability in war/fighting systems of relevance to Air Force interests.

The present invention achieves these effects of these functions by combining nanofluidics and PBCs for implementing the optical analog of a doped semiconductor and, in particular, for dynamically reconfiguring a sub-lattice of “doping” defects in such a way that the states of wave propagation in desired portions of the system changes between extended (in a first state where the wave can propagate) and localized (in a second state where the wave cannot propagate). The reconfiguring of the sub lattice results in the sub lattice being programmable. Under this scheme, PBC defects may be introduced anywhere in the PBC lattice 100 that the algorithm or function determines the location of the extended portion and the location of the localized portion. As a consequence, it is possible to obtain a flexible configuration space of programmable/software/digitally-controlled functions.

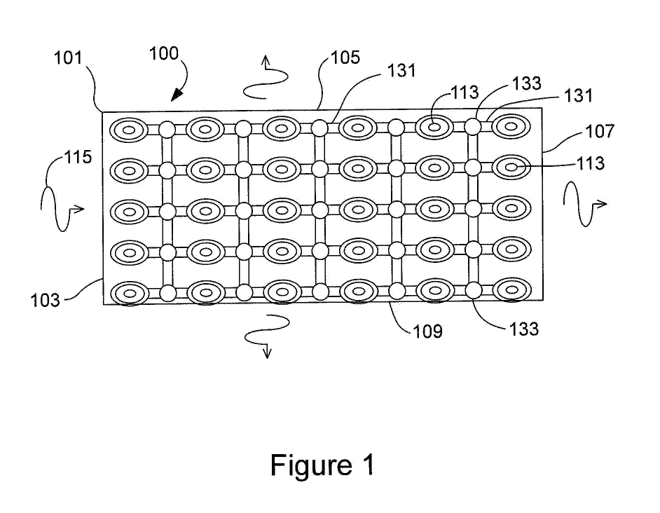

The design of PBCs is known. The design typically entails selecting the lattice geometry, the filling fraction (period and the “atomic” diameter), the refractive indices of the host medium and the “atoms”, and the number of periods, i.e., the overall size. For a two-dimensional representation of the PBC lattice 100, one needs to determine both its length and width. As indicated in FIG. 1, the present invention illustrates the PBC as a lattice of cylindrical air-hole “atoms” in a host dielectric medium. The host medium may be chosen as a silicon-on-insulator wafer (SOI). Extensive normalized data may exist on the dispersion properties of various PBC lattice geometries, in particular, as PBC band gap “maps” of normalized frequency (wa/2pi c) versus r/a, where a and r are the lattice constant and the atomic radius, respectively, and c is the speed of light, and w is the radian frequency which indicate the values of these parameters for which band gaps are obtained for separate or simultaneous field polarizations TE and TM. In addition, full-wave electromagnetic simulators, such as Lumerical, may be used to analyze/design the host PBC lattice 100. For a band gap centered substantially at 1550 nm, a triangular lattice PBC on silicon-on-insulator substrate with a substantially 0.2 micron-thick single-crystal Si layer, a substantially refractive index n=3.48) on a substantially 1.0 micron SiO₂ (n=1.45) layer, with a substantially 0.55 micron-deep, a substantially 0.13 micron radii air holes (n=1), and a substantially 0.42 micron lattice constant may be chosen as a example.

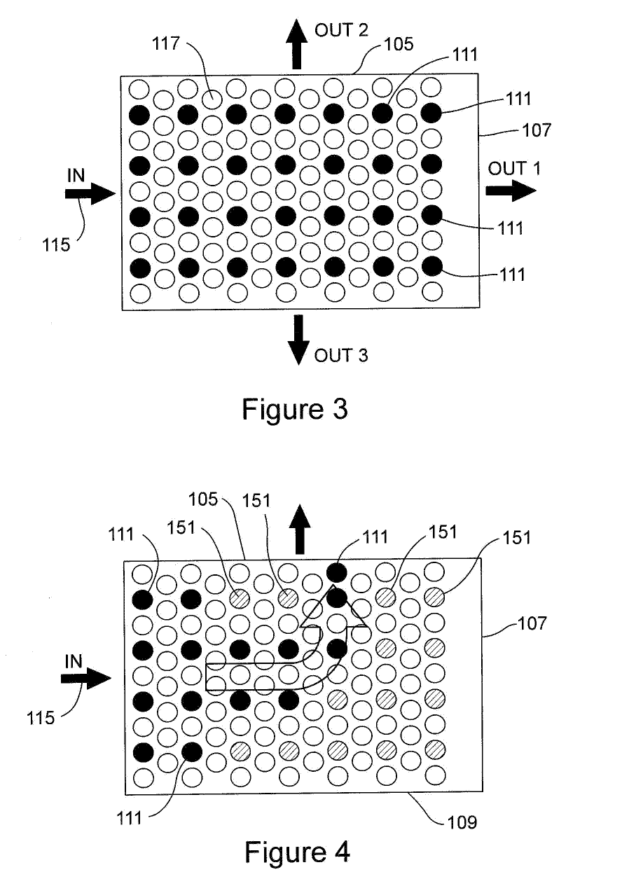

The present invention has found that changing the refractive index of the air-holes will disrupt the PBC periodicity, thus introducing defects in the lattice at a particular location where the refractive index has been changed. Changing the refractive index in turn, introduce frequencies of allowed propagation in the forbidden band gap. By appropriately and judiciously distributing the defects, the beam may be steered. FIG. 1 illustrates a top view of the PBC lattice 100 and illustrates fluid valves 133 which may be interconnected by passageways 131 which may carry fluid to apertures 113. The fluid valves 133 may be activated to open and close and to selectively allow the fluid to flow into the aperture 113 or to restrict the fluid from flowing into the aperture 113. A micro-fluid circuit controller may control the fluid valves 133 to create the second lattice of defects 111 (as shown in FIG. 3) within the PBC lattice 100. The second lattice of defects 111 may be considered programmable.

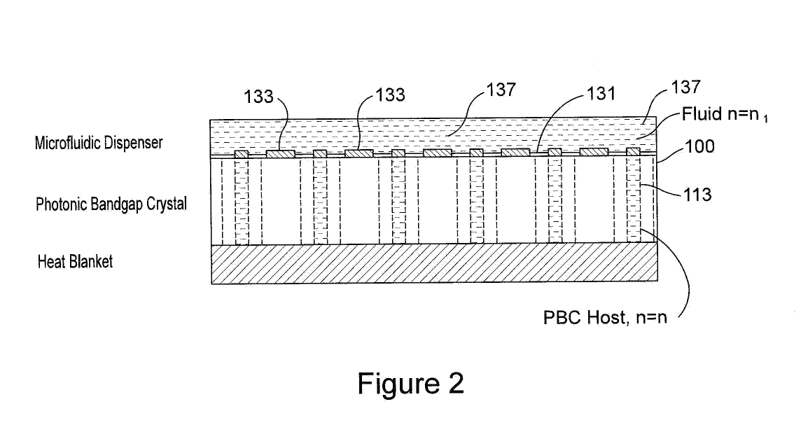

FIG. 2 illustrates a cross-sectional side view of the PBC lattice 100 and illustrates a layer of fluid 137 which may extend over the top surface of the PBC lattice 100 which may flow through the fluid valves 133 and flow through the passageway 131 to a target aperture 113 to create a lattice of defect 111. Alternatively, fluid could be directed away from the target aperture 113 to eliminate the lattice of defect 111. By selectively continuing this process throughout the PBC lattice 100 the input light 115 can be directed or bent so that the input light can be selectively directed to output at the first output surface 105, the second output surface 107 or the third output surface 109 or any combination of the surfaces. A heat blanket 139 may extend across the bottom surface of the PBC lattice 100 to provide heat to the PBC lattice 100.

FIG. 3 illustrates a PBC lattice 100 that has been configured by selectively placing the lattice of defects 111 throughout the PBC lattice 100 and illustrates that the input light 115 enters in a first input surface in any input direction may be distributed out the first output surface 105 in a first direction which may be substantially 90° from the input direction, the second output surface 107 and a second direction which may be in the input direction and the third output surface 109 and a third direction which may be substantially 90° from the input direction and substantially 180° from the first direction.

FIG. 4 illustrates a PBC lattice 100 that has been reconfigured by reconfiguring the placement of the lattice of defects 111 throughout the PBC lattice 100 and illustrates that the input light 115 may substantially be distributed out of the first output surface 105 and the second output surface 107 and the third output surface 109 may have no or little output light due to the reconfiguration of the lattice of defects 111. Comparing FIG. 3 and FIG. 4, the lattice 151 having been previously a portion of the lattice of defects 111 has been drained of fluid and is no longer a lattice of defect. The lattice 151 is substantially a lattice of no defect 117.

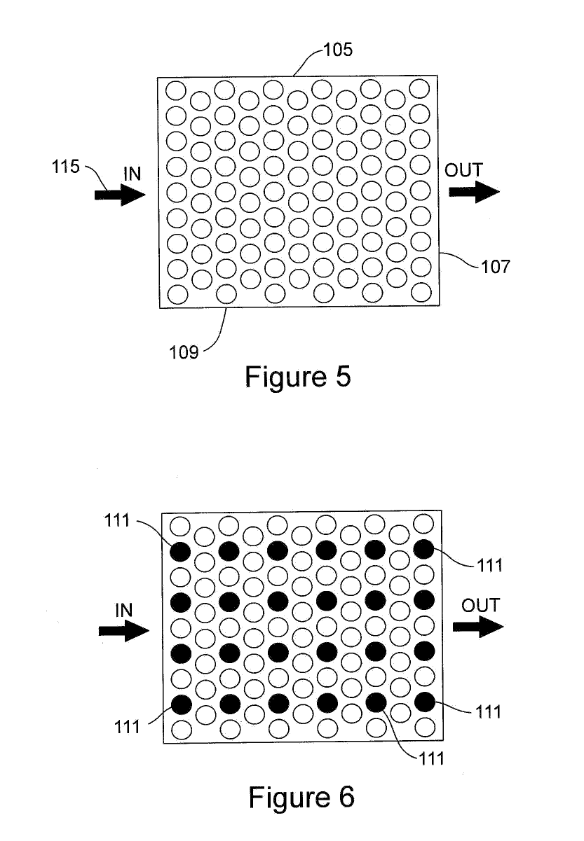

FIG. 5 illustrates a PBC lattice 100 with substantially no lattice of defects 111 and consequently the input light travels substantially attenuated out the second output surface 107 within the band gap. FIG. 6 illustrates substantially the same results as illustrated in FIG. 5 but with a configuration of lattice of defects 111 which introduces frequencies of wave propagation within the band gap.

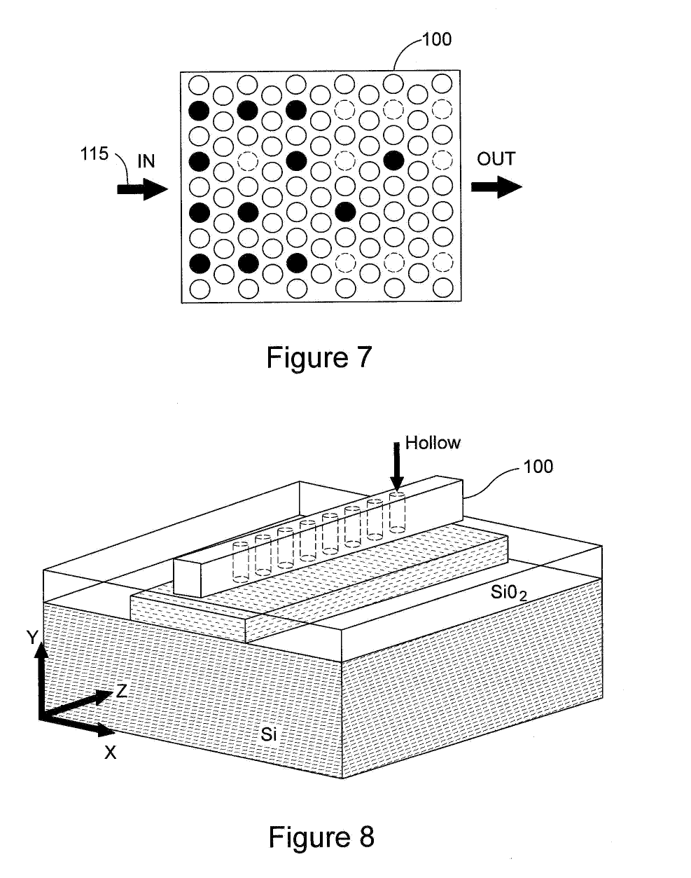

FIG. 7 illustrates that the lattice of defects 111 has been reconfigured such that no light is output from the PBC lattice 100.

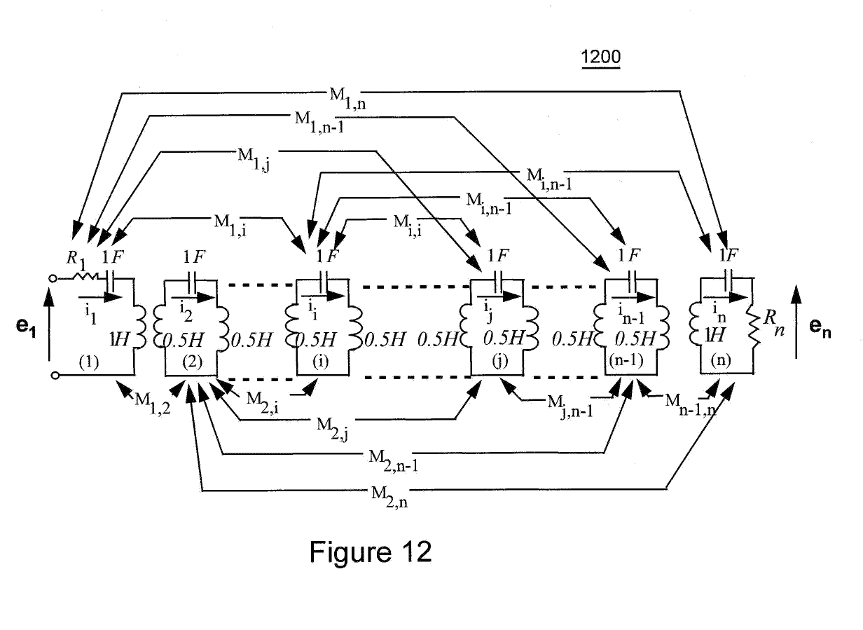

As discussed before, changing the refractive index of the cylindrical air-holes may disrupt the PBC periodicity, thus introducing defects in the lattice. These, in turn, introduce frequencies of allowed propagation of light In the forbidden band gap. Physically, the behavior of these defects may be modeled as Fabry-Perot resonators, or as dielectric resonators embedded in a cutoff waveguide, in which the field decays away with distance from the n₁/n₂ interface into the surrounding host medium. Electrically, the adjacent defects may be modeled as coupled resonators which, as in microwave filters, determine the overall transmission characteristics. Thus, properly designed and coupled defects may be used as light-guides. On the other hand, the electrical approximation of the defects may be represented as RLC resonators. FIG. 12 illustrates a circuit 1200 which may be exploited for analysis and design purposes using a circuit simulator with optimization capabilities.

The present invention takes advantage of the individual defects in order to characterize their consequences as a function of their geometry, i.e., radius, and fluid level and refractive index, will involve calculating spatial field distributions of the resonator fields with a full wave field stimulator. A variety of fluids are employed in optofluidics, for instance, water (with properties substantially of n=1.32 @λ0=1550 nm), and a solution of 35% KI and 15% NaBr by weight in water (n=1.39 @ λ₀). In this regard, the present invention varies the nature of the properties of the formed defects when these and other liquids fill the substantially cylindrical holes or other shapes holes up to various levels. Both individual and the standard configuration of the “linear defect,” (i.e., a line of adjacent defects) may be considered a part of the present invention under the definition of defect. The end result of this design process will be the field distribution and decay length of the defects as a function of filling level, diameter and refractive index, the coupling coefficient between defects as function of their separation, and the equivalent electrical resonator circuit models.

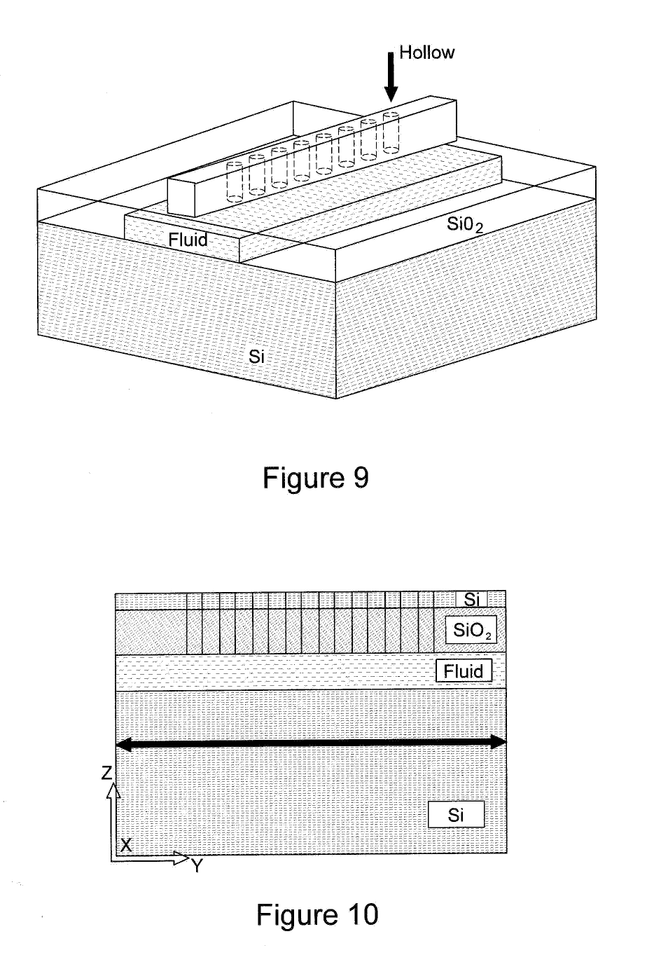

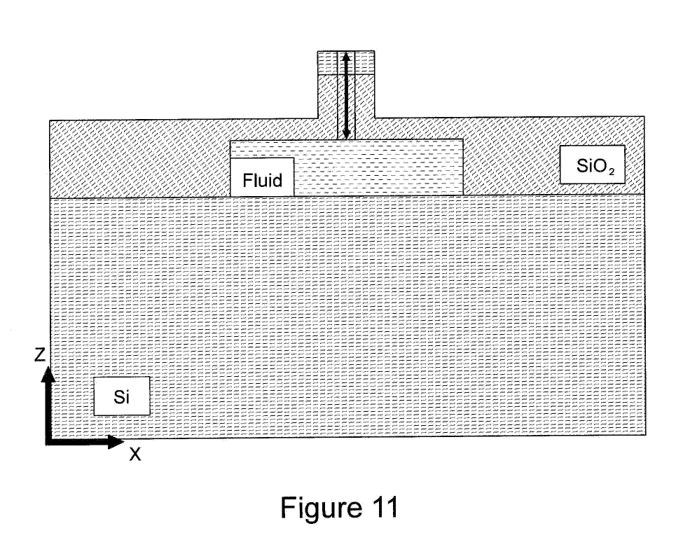

FIGS. 8-11 illustrates an implementation of the concept, based on a one-dimensional (1-D) PBC lattice. A fluid deposit is created underneath a one-dimensional lattice of cylindrical air holes patterned in a Si layer of an SOI wafer. Due to capillary forces, the fluid is driven upwards into the air holes, consequently filling near all of them. Then, by designing a system (not shown in FIG. 8) of individually addressable defects, one could create any desired defect pattern (i.e., set of fluid-filled air holes) in the PBC. The incoming optical signal would enter the system at the point labeled “In,” and would propagate towards the point labeled “Out,” on the top silicon layer. The transmission properties, e.g., the delay and frequency content of the output signal, will be a function of the defect pattern (the set of fluid-filled air holes) realized. The fluidics system would be placed on top of the Si PBC wafer and bonded to it.

The advantages of the present invention include that the device is passive, not requiring electricity or heat to maintain a position.

Therefore, it exhibits low power consumption.

The present invention is virtually reconfigurable by software. The desired effect can be input into software and the software may generate the pattern of refractive index that should generate the desired effect

The present invention is scalable, i.e., by proper dimensioning, the concept can be extended/tailored for operation at a large number of frequencies/wavelengths.

### Alternatives

In addition to implementation use in silicon-on-insulator (SOI) wafers, the present invention may be constructed in substantially any machineable substrate materials, such as III-V semiconductors, glass, alumina, and many others.

While specific terms have been used with the present invention, other terms may be used such as “host lattice” maybe interchangeable with “PBC lattice”, “substrate” maybe interchangeable with “wafer”, “microfluidic” maybe interchangeable with “nanofluidic”, “defects” maybe interchangeable with “atoms” and “bandgap” may be interchangeable with “band gap”

The present invention can be used in various devices and/or functions. The device could be used as an optical switch. The device could be used as an optical absorber by filling the defect holes with a lossy fluids. The device could be used as an optical modulator. Instead of, e.g., an SOI wafer, the solid host lattice could be implemented as a substantially hollow “mold” which may be fill able by a fluid different than that for creating the defect holes.

The present invention dynamically configures a set of defects so as to create a light-guide device to bend the light at a substantially a 90-degree angle or other appropriate angle, see FIG. 4. For example, by adjusting the “doping” of the PBC to introduce sub-lattice which may include defects to establish an extended (delocalized) state, light waves may freely propagate through the PBC of FIG. 4. In this case a light wave input to the lightguide device 101 at the input surface 103 may be steered based upon the defects to exit through one or more of the first output surface 105, the second output surface 107 or the third output surface 109. The lightguide device 101 may be a rectangle, triangle, oval or other shapes device. To effect steering, the defects would be, for instance, redistributed by microfluidic action, i.e., emptying/eliminating some defects to define the path to be followed by the light, FIG. 4. The coupling of the light may be into and out of the bend region which may be defined by the input surface 103, the first output surface 105, the second output surface 107 and the third output surface 109 or the bend region may be defined as substantially a line of defects. One example, is illustrated in FIG. 4 which illustrates a PBC lattice with micofluidically defined sub-lattice of defects which may be illustrated by the element 111. The sub-lattice of defects 111 may be dynamically reconfigured via the emptying of a set of liquid apertures 113 which may be a cylindrical holes so the input signal of input light 115 is steered substantially 90-degrees towards the first output surface 105. The liquid apertures 113 may be filled with liquid in order to introduce a defect, and the liquid apertures 113 may be drained to be substantially liquid free in order to eliminate the defect. The microfluidic network to control the filling and emptying of the apertures 113 is not shown.

The input light 115 will be transmitted through the lattice of defects 111 which defined the bend. In order to determine the lattice of defects 111, a two-step process may be used. In a first step, the present invention may approximate the defect-populated PBC which may be defined by the lattice at defects 111 by a set of coupled electric circuit resonators, and the second step the overall transmission can be determined via optimization in a circuit simulator such as Microwave Office. Once optimized in terms of lowest insertion loss and largest bandwidth, the present invention may simulate the lattice of defects 111 in a full wave simulator such as Lumerical and fine-tune it.

The present invention dynamically configures a set of defects in PBC lattice so as to reduce the velocity of a propagating light pulse until it stops or is localized, FIG. 7. The present invention includes the steps of: 1) Design a host PBC; 2) Configure a sub-lattice of defects 111 so that all defects may be substantially strongly coupled and propagation is free (this is effected by filling the cylindrical air-holes); 3) Randomly “remove” defects (this is achieved by emptying the liquid-filled holes) so they are decoupled and propagation through the system is via hopping and eventually (for large separations among the remaining defects) stops. The random distribution of the defect atoms among the host PBC atoms (air-holes) will be carried out by a program to simulate electron transport via hopping or a random number generator. The design process may also begin with the coupled electric resonator simulation of the system in Microwave Office before performing full wave simulations.

FIG. 7 illustrates a top view of the PBC and illustrates the change in refractive index of the strategically located defects 111 by morphing the periodic PBC structure from above to below percolation threshold.

The portion of the PBC with no defects 117 may include inside band gap frequencies, substantially all fields inside PBC may be evanescent/exponentially decaying, so propagation may be substantially forbidden. The introduction of sub-lattice of defects 111 may introduce frequencies/states of free propagation within the band gap of the PBC. By varying the coupling/distance between defects of the sub lattice of defects 111 the propagation may be varied from the free to the hopping regime. Gradual/adiabatic spatial random distribution of defects, and reduced coupling among defects, results in gradual reduction of group velocity until zero velocity is reached when field distribution around defects cannot couple to any adjacent defects. At this point, light is stopped and stored.

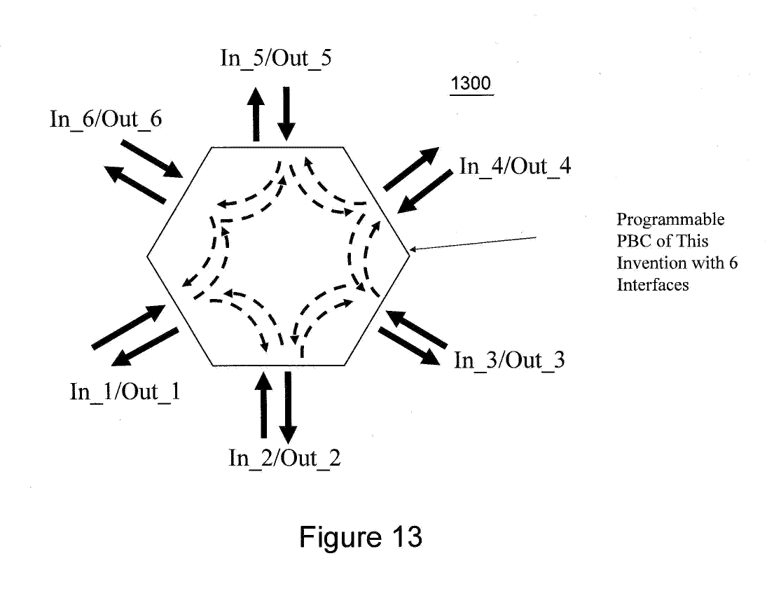

The present invention shows the PBC lattice to be substantially rectangular, other shapes such as circular, oval, triangular or other such shapes are within the scope of the present invention. The PBC can be reconfigured/programmed, so optical signals can get in and out between any two or more interfaces. The maximum number of interfaces is, in principle, infinite when the shape of the lightguide is a circle. FIG. 13 illustrates an alternate shaped PBC lattice 1300 in accordance with the teachings of the present invention. FIG. 13 illustrates that any side may be able to input/output the light input 115 including the situation where the input surface is the same as the output surface.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A light guide device for steering an input light, comprising;
a PBC lattice having a input surface and a first surface;
the input surface receiving the input light to cooperate with the first surface;
the PBC lattice directing the input light to the first surface to output the light from the PBC lattice by a programmable lattice of defect.

2) A light guide device for steering an input light as in claim 1, wherein the PBC lattice includes a aperture adapted to be filled with fluid.

3) A light guide device for steering an input light as in claim 2, wherein the PBC lattice includes a fluid valve adapted to cooperate with the aperture.

4) A light guide device for steering an input light as in claim 3, wherein the PBC lattice includes a layer of fluid to cooperate with the fluid valve and the aperture.

5) A light guide device for steering an input light as in claim 1, wherein the PBC lattice includes a second surface for output of the light by reprogramming the lattice of defect.

6) A light guide device for steering an input light as in claim 5, wherein the PBC lattice includes a third surface for output of the light by reprogramming the lattice of defect.

7) A light guide device for steering an input light as in claim 1, wherein the first surface is substantially perpendicular to the input surface.

8) A light guide device for steering an input light as in claim 5, wherein the second surface is substantially perpendicular to the input surface.

9) A light guide device for steering an input light as in claim 6, wherein the third surface is substantially perpendicular to the input surface and substantially parallel to the first surface.
